(19) United States
(12) Patent Application Publication
(10) Pub. No.: US 2011/0267511 A1
(43) Pub. Date: Nov. 3, 2011

(54) CAMERA

(75) Inventor: Kazuharu IMAFUJI, Kawasaki-shi (JP)

(73) Assignee: NIKON CORPORATION, Tokyo (JP)

(21) Appl. No.: 13/049,304

(22) Filed: Mar. 16, 2011

(30) Foreign Application Priority Data
Mar. 18, 2010 (JP) 2010-062736

(51) Int. Cl. H04N 5/335

(52) U.S. Cl. 348/294; 348/E05.091

(57) ABSTRACT

A camera includes an image sensor that includes a first pixel row at which a plurality of first pixels that output focus adjustment signals are disposed, and second pixel rows each made up exclusively with a plurality of second pixels that output image data generation signals; and an interpolation processing device that executes, when outputs from a plurality of pixel rows are provided as a combined output according to a predetermined combination rule, interpolation processing for an output from a specific second pixel row which would be combined with an output from the first pixel row according to the predetermined combination rule, by using the output of the specific second pixel row and a combined output of second pixel rows present around the specific second pixel row.

### INCORPORATION BY REFERENCE

The disclosures of the following priority application and publications are herein Incorporated by reference: Japanese Patent Application No. 2010-062736 filed Mar. 18, 2010, Japanese Laid Open Patent Publication No. 2009-94881, and Japanese Laid Open Patent Publication No. 2009-303194.

### BACKGROUND OF THE INVENTION

1. Field of the Invention

The present invention relates to a camera.

2. Description of Related Art

Japanese Laid Open Patent Publication No. 2009-94881 discloses an image sensor that includes focus adjustment pixels and determines pixel values corresponding to the focus adjustment pixels in an image obtained thereat, through interpolation executed by using pixel values indicated at nearby pixels.

### SUMMARY OF THE INVENTION

While interpolation methods adopted in image-capturing devices in the related art enable generation of pixel data in still images through interpolation, a viable interpolation method to be adopted for video shooting is yet to be devised.

A camera according to a first aspect of the present invention comprises: an image sensor that includes a first pixel row at which a plurality of first pixels that output focus adjustment signals are disposed, and second pixel rows each made up exclusively with a plurality of second pixels that output image data generation signals; and an interpolation processing device that executes, when outputs from a plurality of pixel rows are provided as a combined output according to a predetermined combination rule, interpolation processing for an output from a specific second pixel row which would be combined with an output from the first pixel row according to the predetermined combination rule, by using the output of the specific second pixel row and a combined output of second pixel rows present around the specific second pixel row.

According to a second aspect of the present invention, in the camera according to the first aspect, the interpolation processing device may execute the interpolation processing in a second video shooting state, in which a video image is shot by adopting a second focus adjustment method whereby focus adjustment is executed based upon outputs of the second pixels.

According to a third aspect of the present invention, the camera according to the second aspect may further comprise a switching device capable of switching to one of the second video shooting state and a first video shooting state in which a video image is shot by adopting a first focus adjustment method whereby focus adjustment is executed based upon outputs of the first pixels, and it is preferable that the interpolation processing device selects an interpolation processing method in correspondence to a shooting state selected via the switching device.

According to a fourth aspect of the present invention, in the camera according to the third aspect, it is preferable that the interpolation processing device executes the interpolation processing by altering a volume of information used in the interpolation processing in correspondence to the shooting state.

According to a fifth aspect of the present invention, in the camera according to the third aspect, the interpolation processing device may use a greater volume of information in the interpolation processing in the second video shooting state than in the first video shooting state.

According to a sixth aspect of the present invention, in the camera according to the second aspect, the first video shooting state may include at least one of a video shooting state in which a video image is shot and is recorded into a recording medium and a live view image shooting state in which a video image is shot and displayed at a display device without recording the video image into the recording medium.

According to a seventh aspect of the present invention, the camera according to the first aspect may further comprise a third shooting state in which a still image is shot, and it is preferable that the switching device is capable of switching to the first video shooting state, the second video shooting state or the third shooting state; and once the switching device switches to the third shooting state, the interpolation processing device executes interpolation processing to generate image data generation information corresponding to the first pixels through an interpolation processing method different from the interpolation processing method adopted in the first video shooting state or the second video shooting state.

According to a eighth aspect of the present invention, in the camera according to the seventh aspect, in the third shooting state, the interpolation processing device may execute interpolation processing to generate the image data generation information corresponding to each of the first pixels by using an output of the first pixel and outputs of the second pixels present around the first pixel.

According to a ninth aspect of the present invention, in the camera according to the first aspect, the interpolation processing device may adjust a number of second pixels used in the interpolation processing in correspondence to a frame rate at which the video image is shot.

According to a tenth aspect of the present invention, in the camera according to the ninth aspect, it is preferable that the interpolation processing device executes the interpolation processing by using a smaller number of second pixels at a higher frame rate.

According to a eleventh aspect of the present invention, in the camera according to the first aspect, it is preferable that the interpolation processing device, determines combination ratios for outputs of the second pixels used in the interpolation processing in correspondence to distances between each first pixel and the second pixels used in the interpolation processing.

### BRIEF DESCRIPTION OF THE DRAWINGS

FIG. 1 is a block diagram showing the structure adopted in a camera achieved in an embodiment of the present invention.

FIG. 2 is a schematic illustration showing how pixels in an image sensor that includes AF pixel rows may be disposed in a partial view.

FIG. 3 presents a flowchart of the operations executed in the camera.

FIG. 4 is a schematic illustration showing the interpolation processing operation executed in a live view shooting mode.

FIG. 5 is a schematic illustration showing the interpolation processing operation executed in a still image shooting mode.

FIG. 6 is a schematic illustration showing the interpolation processing operation executed in a contrast AF video shooting mode.

FIG. 7 is a schematic illustration showing the interpolation processing operation executed in a phase difference AF video shooting mode.

### DESCRIPTION OF PREFERRED EMBODIMENT

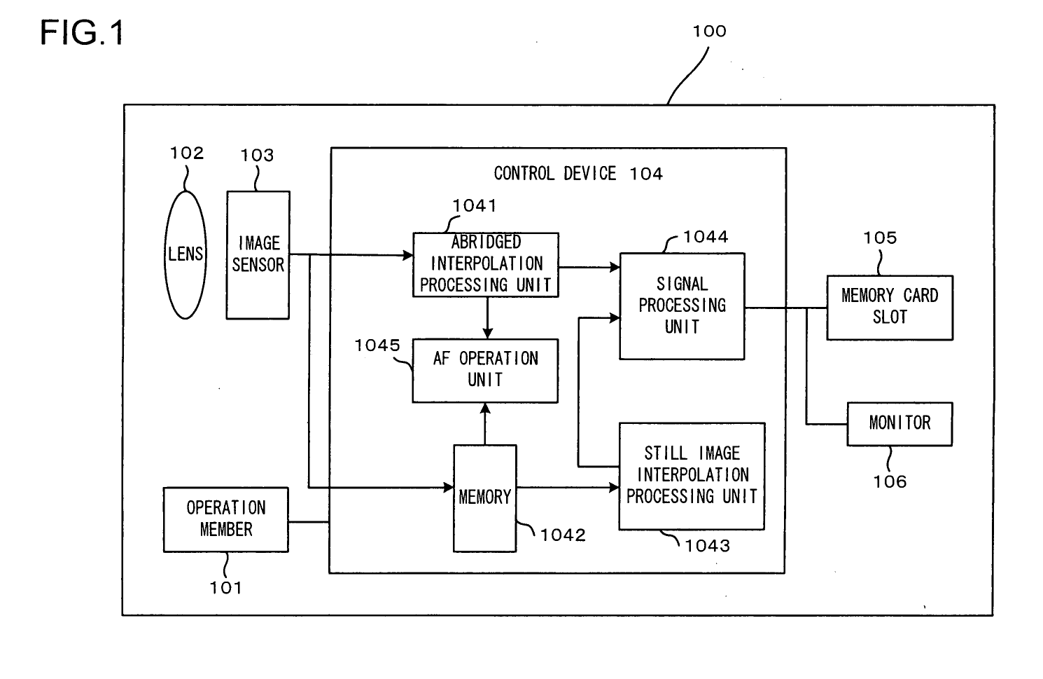

FIG. 1 is a block diagram showing the structure adopted in an embodiment of the camera according to the present invention. The camera 100 comprises an operation member 101, a lens 102, an image sensor 103, a control device 104, a memory card slot 105 and a monitor 106. The operation member 101 includes various input members operated by the user, such as a power button, a shutter release button via which a still shooting instruction is issued, a record button via which video shooting (video recording) start/end instructions are issued, a live view button via which a live view display instruction is issued, a zoom button, a cross-key, a confirm button, a reproduce button, and a delete button.

While the lens 102 is actually a plurality of optical lenses, FIG. 1 shows a single representative lens. It is to be noted that the lenses constituting the lens 102 include a focus adjustment lens (AF lens) used to adjust the focusing condition.

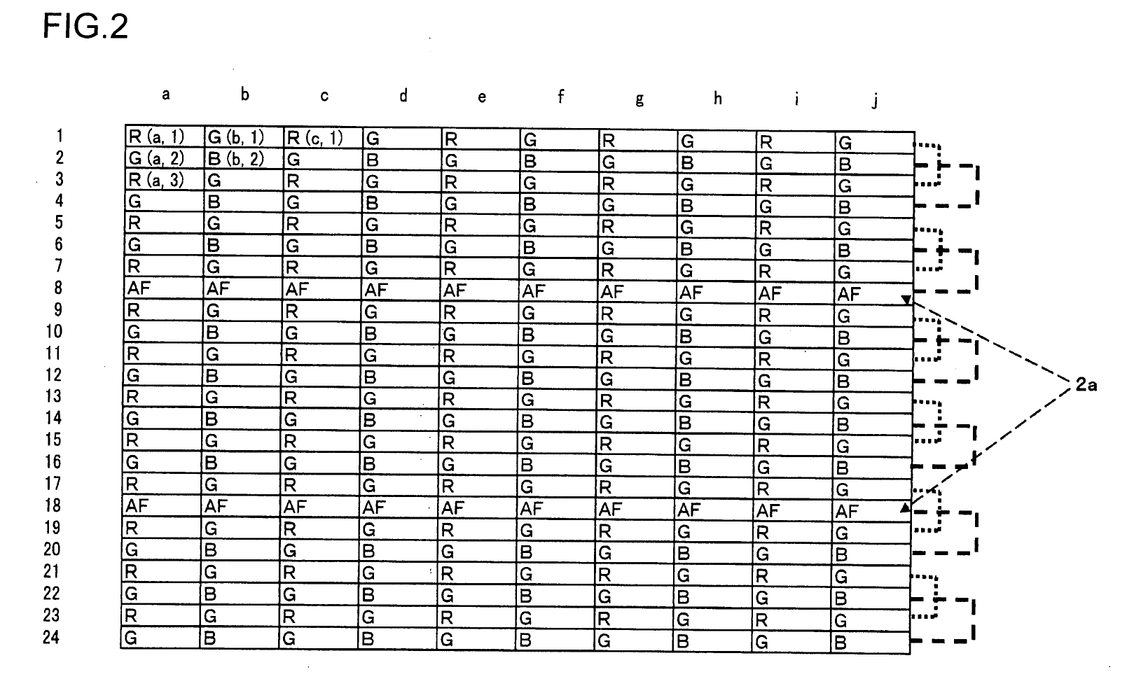

The image sensor 103 is equipped with both pixels that output focus adjustment signals (hereafter referred to as AF pixels) and pixels that output image data generation signals (hereafter referred to as regular pixels). FIG. 2 is a schematic illustration of part of the image sensor 103 in the embodiment, showing how the pixels at such an image sensor may be disposed. FIG. 2 only shows the pixel array pattern adopted at the image sensor 103 over an area of 24 rows (lines)×10 columns. As shown in FIG. 2, the image sensor 103 is made up with pixel rows 2a from which AF signals to be used for purposes of focus adjustment are output (hereafter referred to as AF pixel rows) and pixel rows from which image signals to be used for purposes of image data generation are output (hereafter referred to as regular pixel rows). The regular pixel rows are made up with pixel rows in which an R pixel and a G pixel are disposed alternately to each other and pixel rows in which a G pixel and a B pixel are disposed alternately to each other. The camera 100 adopts a structure that enables it to execute focus detection operation through a phase difference detection method of the known art, such as that disclosed in Japanese Laid Open Patent Publication No. 2009-94881, by using signals provided from the AF pixels in an AF pixel row 2a. It is to be noted that the camera 100 is also capable of executing focus detection operation through a contrast detection method of the known art by using signals provided from the regular pixels in a regular pixel row.

The image sensor 103 switches signal read methods in correspondence to the current operating state (operation mode) of the camera 100. When the camera 100 is currently set in a still image shooting state (still shooting mode), an all-pixel read is executed so as to read out the signals from all the pixels at the image sensor 103, including both the AF pixels and the regular pixels. If the camera 100 is set in a video shooting state (video shooting mode) in which a video image to be recorded into a recording medium is captured, to be described later, a combined pixel read is executed so as to read out signals by combining the pixels in same-color pixel rows (a pair of pixel rows). If, on the other hand, the camera 100 is currently set in a live view state (live view mode) in which a video image (referred to as a live view image or a live view image) is captured and provided as a real-time display at the monitor 106 functioning as a display unit, to be described later, a read often referred to as a “culled read” is executed.

In the video shooting mode the image sensor 103 executes a combined pixel read from pairs of same-color pixel rows (pairs of pixel rows each indicated by a dotted line in FIG. 2, e.g., a pair of the first and third rows and a pair of the second and fourth rows), as described earlier. However, the combined pixel read is not executed in conjunction with the AF pixel rows 2a (e.g., the eighth pixel row in FIG. 2) and the regular pixel rows which would be paired up with the AF pixel rows for the combined pixel read (e.g., the sixth pixel row in FIG. 2).

The combined pixel read is not executed in conjunction with the AF pixel rows 2a, which receive light via transparent filters instead of color filters and thus output “white-color light component” signals. Since the pixels in the regular pixel rows each include an R color filter, a G color filter or a B color filter, signals representing R, G and B are output from the pixels in the regular pixel rows. This means that if signals read out through a combined pixel read of white color light signals from the AF pixels and the color signals from the regular pixels were used as focus detection signals, the focus detection accuracy may be compromised, whereas if signals read out through a combined pixel read of white color signals and the color signals were used as image signals, the image quality may be lowered. For this reason, when the camera is set in the video shooting mode, in which a combined pixel read is executed, the image sensor 103 exempts each AF pixel row and the regular pixel row that would otherwise be paired up with the AF pixel row from the combined pixel read and instead, reads out signals from either the AF pixel row or the regular pixel row.

Under such circumstances, the image sensor 103 switches to either the AF pixel row 2a or the regular pixel row for reading out the signals, in correspondence to the specific focus detection method adopted in the video shooting mode. More specifically, if the phase difference detection method is selected as the focus detection method, the signals from the AF pixel row 2a are read out, whereas if the contrast detection method is selected as the focus detection method, the signals from the regular pixel row are read out. In addition, the image sensor 103 is controlled in the live view mode so as to read out the signals from the AF pixel row 2a without skipping them, i.e., so as to designate some of the regular pixel rows as culling target pixel rows. The various read methods listed above will be described in further detail later.

The control device 104 includes an abridged interpolation processing unit 1041, a memory 1042, a still image interpolation processing unit 1043, a signal processing unit 1044 and an AF (autofocus) operation unit 1045.

The abridged interpolation processing unit 1041 is engaged in operation when either the video shooting mode or the live view mode is set as the camera operation mode. The abridged interpolation processing unit 1041 executes interpolation processing to generate image signals for the AF pixel row 2a that outputs focus adjustment AF signals. The interpolation method adopted in the abridged interpolation processing unit 1041 will be described in specific detail later.

The memory 1042 includes an SDRAM and a flash memory. The SDRAM, which is a volatile memory, is used as a work memory where a program is opened when the control device 104 executes the program or as a buffer memory where data (e.g., image data) are temporarily stored. In addition, in the flash memory which is a nonvolatile memory, data pertaining to the operation program executed by the control device 104, various parameters to be read out when the operation program is executed, and the like, are recorded.

As the user presses the shutter release button in the operation member 101 halfway down in the still shooting mode, the control device 104 in the embodiment executes focus adjustment by driving the AF lens in the lens 102 based upon AF signals output from the image sensor 103. The AF signals used in this instance indicate the calculation results obtained through the arithmetic operation executed at the AF operation unit 1045, to be described later, based upon phase difference AF signals provided from AF pixels or based upon contrast AF signals provided from regular pixels. Subsequently, as the user presses the shutter release button all the way down, the control device 104 executes photographing processing. Namely, the control device 104 takes image signals output from the image sensor 103 into the SDRAM in the memory 1042 so as to save (store) the image signals on a temporary basis.

The SDRAM has a capacity that allows it to take in still image signals for a predetermined number of frames (e.g., raw image data expressing 10 frames of images). The still image signals having been taken into the SDRAM are sequentially transferred to the still image interpolation processing unit 1043. While the still image interpolation processing unit 1043 fulfills a purpose similar to that of the abridged interpolation processing unit 1041, i.e., the still image interpolation processing unit 1043, too, executes interpolation processing to generate image signals for the AF pixel rows 2a that output AF signals used for focus adjustment, the two interpolation processing units adopt different interpolation processing methods.

Through the interpolation processing executed by the still image interpolation processing unit 1043, which executes interpolation processing by using more information compared to the abridged interpolation processing unit 1041, visually superior interpolation results are achieved compared to the interpolation processing results provided via the abridged interpolation processing unit 1041. The interpolation processing method adopted in the still image interpolation processing unit 1043 will be described in further detail later. It is to be noted that the still image interpolation processing unit 1043 is engaged in operation when the camera 100 is set in the still shooting mode, as has already been described.

The signal processing unit 1044 executes various types of image processing on image signals having undergone the interpolation processing at the abridged interpolation processing unit 1041 or the still image interpolation processing unit 1043 so as to generate image data in a predetermined format, e.g., still image data in the JPEG format or video image data in the MPEG format. It then generates an image file with the image data (an image file to be recorded into a recording medium) to be described later.

The signal processing unit 1044 also generates a display image to be brought up on display at the monitor 106, to be described later, in addition to the recording image in the image file. The display image generated in the live view mode is the live view image itself, the display image generated in the video shooting mode is a video image (similar to the live view image) which is brought up on display at the monitor 106 while the video image to be recorded is being generated, and the display image generated in the still shooting mode is a verification image brought up on display for a predetermined length of time following the still shooting operation so as to allow the user to visually verify the photographed image.

The AF operation unit 1045 calculates a defocus quantity based upon signals provided from AF pixels at the image sensor 103 and also calculates a contrast value based upon signals provided from regular pixels at the image sensor 103. An AF operation is executed via an AF lens control unit (not shown) based upon these calculation results. It is to be noted that the AF operation unit 1045 is configured so as to execute the AF operation in the still shooting mode by taking in the image sensor output (AF pixel outputs or regular pixel outputs) that has been first taken into the memory 1042. In the video shooting mode or the live view mode, on the other hand, it executes the AF operation by taking in the image sensor output (AF pixel outputs or regular pixel outputs) that has been taken into the abridged interpolation processing unit 1041.

At the memory card slot 105, where a memory card used as a recording medium is inserted, an image file having been generated by the control device 104 is written and thus recorded into the memory card. In addition, in response to an instruction issued by the control device 104, an image file stored in the memory card is read at the memory card slot 105.

The monitor 106 is a liquid crystal monitor (backside monitor) mounted at the rear surface of the camera 100. At the monitor 106, an image (live view image) captured in the live view mode, an image (a still image or a video image) stored in the memory card, a setting menu in which settings for the camera 100 are selected, and the like are displayed. In the live view mode, the control device 104 outputs to the monitor 106 the display image data (live view image data) obtained in time series from the image sensor 103. As a result, a live view image (through image) is brought up on display at the monitor 106.

As explained earlier, the image sensor 103 in the camera 100 achieved in the embodiment includes AF pixel rows 2a from which image signals used to generate a still image or a video image are not output. Accordingly, the control device 104 generates image data by determining pixel values for the AF pixel rows 2a through interpolation executed based upon the pixel values at other pixels during the imaging processing.

The interpolation processing executed in correspondence to each frame while the live view image (through image) is displayed at a given frame rate or while a video image is being shot at a given frame rate needs to be completed within the frame rate interval. The interpolation processing executed in the still shooting mode, on the other hand, is required to assure the maximum level of definition in the image but is allowed to be more time-consuming than that executed in the video shooting mode. Accordingly, the control device 104 in the embodiment selects a different interpolation processing method depending upon whether the still shooting mode or another shooting mode, such as the video shooting mode or the live view mode, is set in the camera, i.e., depending upon whether a still image is being shot or one of a live view image and a video image is being shot.

In addition, interpolation processing methods are switched in the video shooting mode, depending upon the currently selected focus detection method, i.e., depending upon whether the phase difference detection method or the contrast detection method is currently selected. Moreover, interpolation processing methods are switched in the video shooting mode or the live view mode (i.e., when a live view image or a video image is being captured) in correspondence to the frame rate as well so as to ensure that the pixel interpolation processing for each frame is completed within the frame rate interval.

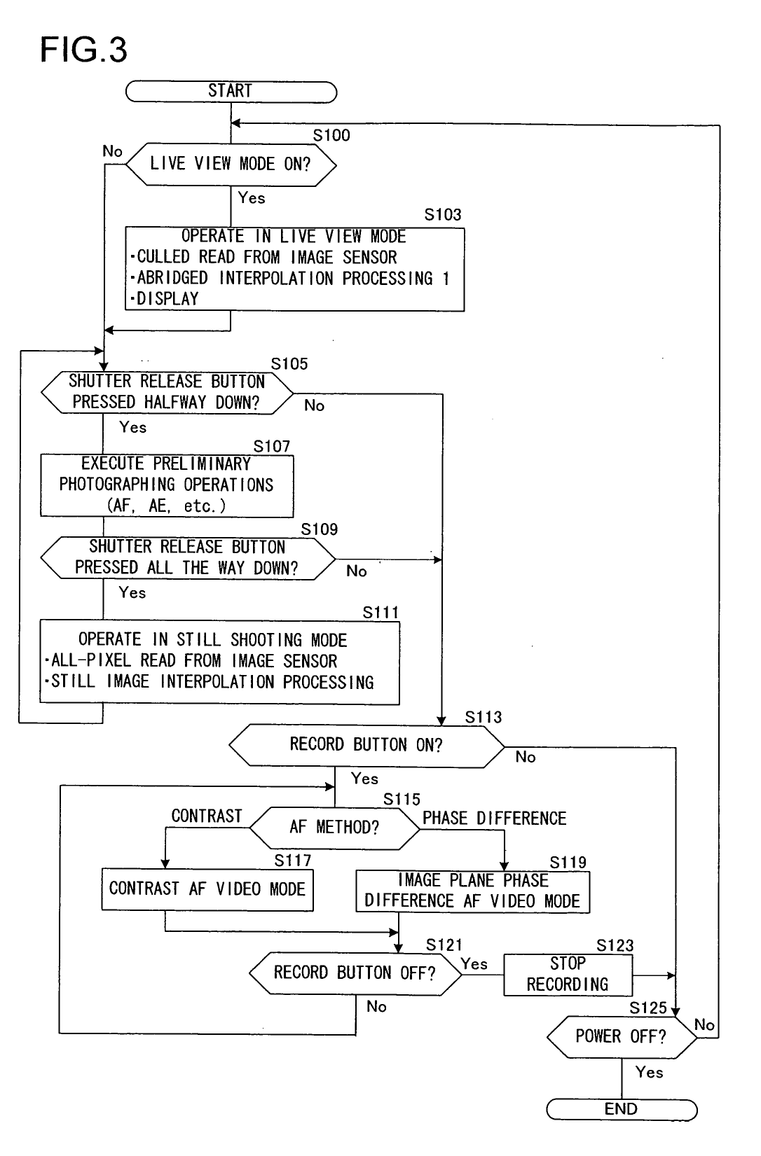

The following is a description of the operations executed in the camera 100 achieved in the embodiment. FIG. 3 presents a flowchart of the operations executed at the camera 100, i.e., the operations executed by the CPU in the camera 100. This operational flow starts as the power to the camera 100 is turned on.

In step S100, a decision is made as to whether or not the live view mode has been set via the live view button (not shown). If the live view mode has been set, the operation proceeds to step S103, but the operation otherwise proceeds to step S105. It is to be noted that the operational flow does not need to include step S100 and that the operation may directly proceed to step S103 as power to the camera 100 is turned on, instead.

In step S103, the camera 100 is engaged in operation in the live view mode. The following is a summary of the live view mode operation. The image sensor 103 executes a culled read, and the control device 104 engages the abridged interpolation processing unit 1041 in abridged interpolation processing and brings up a display image (live view image) generated via the signal processing unit 1044 on display at the monitor 106. The operation executed in step S103 will be described in further detail later. Upon executing the processing in step S103, the operation proceeds to step S105.

It is to be noted that the AF (autofocus) operation is executed in the live view mode by using, in principle, the output from an AF pixel row 2a through the phase difference detection method. However, if the AF detection area is set over a range where no AF pixels are present or if the reliability of the AF pixel outputs is low, the detection method is switched to the contrast detection method so as to execute the AF operation by using the outputs from the regular pixels present around AF pixels. It is to be noted that the reliability of the AF pixel outputs depends upon the waveforms of the signals output from the AF pixels, the detected defocus quantity and the like. If the signal waveforms are altered due to light flux vignetting, noise or the like or if the detected defocus quantity is extremely large, the reliability is judged to be low.

In step S105, a decision is made as to whether or not the shutter release button at the camera 100 has been pressed halfway down. If a halfway press operation has been performed, the operation proceeds to step S107, but the operation otherwise proceeds to step S113. In step S107, a focus detection operation and an exposure control operation are executed for the subject. The focus detection operation is executed, in this step through the phase difference detection method based upon the output from an AF pixel row 2a at the image sensor 103 in principal. However, the focus detection operation is executed in this step through the contrast detection method based upon regular pixel outputs for a subject with which focus detection cannot be executed based upon the AF pixel row output, with the subject being not suited to the phase difference detection method.

In the following step S109, a decision is made as to whether or not the shutter release button has been pressed all the way down. If a full press operation has been performed, the operation proceeds to step S111, but the operation otherwise proceeds to step S113. In step S111, the camera 100 is engaged in operation in the still shooting mode. The following is a summary of the operation executed in the still shooting mode. The image sensor 103 executes an all-pixel read, and the control device 104 engages the still image interpolation processing unit 1043 in interpolation processing and brings up a verification image generated via the signal processing unit 1044 on display at the monitor 106. The operation executed in step S111 will be described in further detail later. Upon completing the processing in step S111, the operation returns to step S105 to repeatedly execute the processing described above.

In step S113, a decision is made as to whether or not the record button has been turned to ON. If the record button has been set to ON, the operation proceeds to step S115, but the operation otherwise proceeds to step S125, to be described in detail later. In step S115, a decision is made as to which of the two AF methods, i.e., the phase difference AF method, which uses AF pixel outputs, and the contrast AF method, which uses regular pixel outputs, is currently in effect. If the contrast AF method is currently in effect, the operation proceeds to step S117, whereas if the phase difference AF method is currently in effect, the operation proceeds to step S119.

As in the live view mode described earlier, the AF operation is executed, in principle, through the phase difference detection method by using the output from an AF pixel row 2a in the video shooting mode. However, if the user has selected an AF detection area where no AF pixels are present (i.e., if the user has selected an area where only regular pixels are present), if the camera has automatically selected (based upon subject recognition results) an AF detection area without any AF pixels, or if the reliability of the AF pixel outputs is low, the AF operation is executed by switching to the contrast AF method, as explained earlier. The switchover from the phase difference AF method to the contrast AF method and vice versa is determined by the control device 104.

In step S117, to which the operation proceeds upon determining that the camera is currently in a contrast AF video shooting state, the camera 100 is engaged in operation in a contrast AF video mode. The following is a summary of the operation executed in the contrast AF video mode. The image sensor 103 executes a combined pixel read by exempting the AF pixel rows 2a from the combined pixel read. The control device 104 engages the abridged interpolation processing unit 1041 in interpolation processing, and brings up a video image (a video image similar to a live view image, which is brought up on display at the monitor 106 while the video image to be recorded is being generated) generated via the signal processing unit 1044 on display at the monitor 106. The AF operation is executed through the contrast AF method in this situation. The operation executed in step S117 will be described in further detail later. Once the processing in step S117 is completed, the operation proceeds to step S121.

In step S119, to which the operation proceeds upon determining that the camera is currently in a phase difference AF video shooting state, the camera 100 is engaged in operation in a phase difference AF video mode. The following is a summary of the operation executed in the phase difference AF video mode. The image sensor 103 executes a combined pixel read. During this combined pixel read, the outputs from the AF pixel rows 2a are also read out. The control device 104 engages the abridged interpolation processing unit 1041 in interpolation processing, and brings up a video image (similar to a live view image) generated via the signal processing unit 1044 on display at the monitor 106. It is to be noted that the AF operation is executed, in principle, through the phase difference AF method by using the outputs from AF pixels.

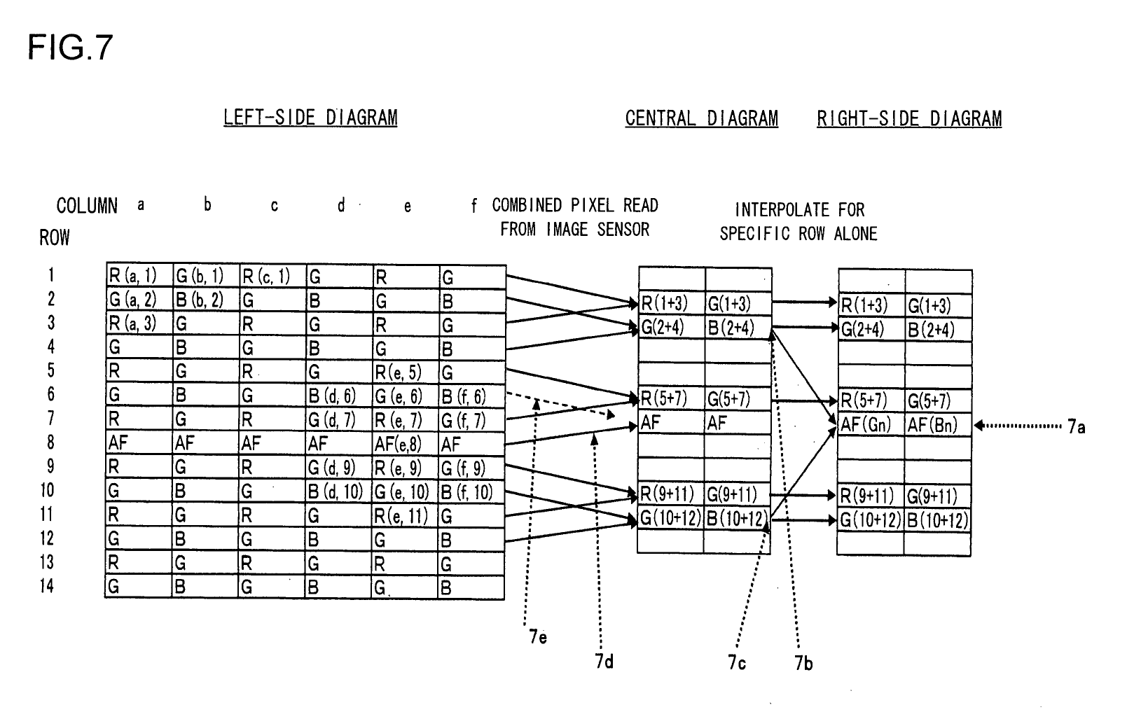

However, if the AF pixel output reliability is low as in the case described earlier in reference to step S103, the AF method is switched to the contrast AF method so as to execute the AF operation by using the contrast value determined based upon a combined pixel read output originating from nearby regular pixels (e.g., either a combined pixel read output 7b or a combined pixel read output 7c closest to the pixel row 7a in the right-side diagram in FIG. 7). It is to be noted that the reliability of the AF pixel outputs (from the eighth row in FIG. 7) is constantly judged while the phase difference AF video mode is on, and the AF method is switched from the contrast AF method to the phase difference AF method once the reliability is judged to have improved.

The operation executed in step S119 will be described in further detail later. Upon completing the processing in step S119, the operation proceeds to step S121. In step S121, a decision is made as to whether or not the record button has been turned to ON again. If it is decided that the record button has been set to ON again, the video shooting operation (video recording operation) having started in step S113 is stopped (step S123) and then the operation proceeds to step S125. However, if it is decided that the record button has not been set to ON again, the operation proceeds to step S115 to repeatedly execute the processing described above so as to carry on with the video shooting operation.

In step S125, a decision is made as to whether or not the power button has been turned to OFF. If it is decided that the power button has not been set to OFF, the operation returns to step S100 to repeatedly execute the processing described above, whereas if it is decided that the power button has been set to OFF, the operational flow ends.

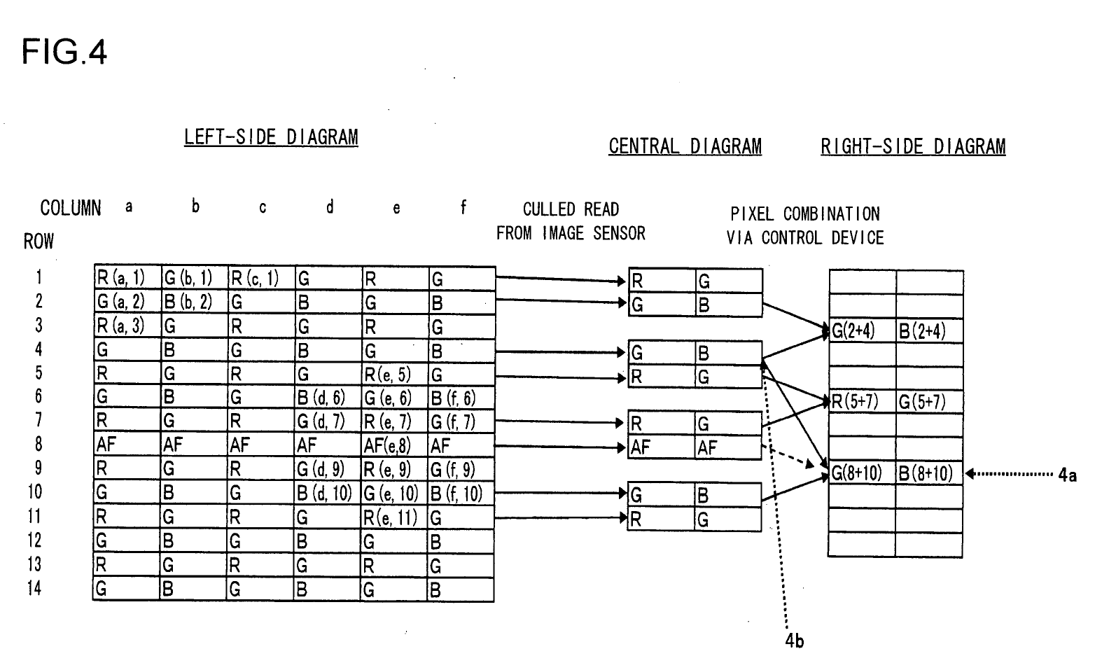

Now, in reference to FIG. 4, the operation executed in the live view, mode in step S103 is described in further detail. In the left-side diagram in FIG. 4, part of the image sensor 103 having been described in reference to FIG. 2, is shown (part of the image sensor over a range from the first through fourteenth rows). In the central diagram in FIG. 4, signals read out from the image sensor 103 through a culled read are shown in clear correspondence to the left-side diagram. In the right-side diagram in FIG. 4, the interpolation method adopted in the abridged interpolation processing unit 1041 of the control device 104 when executing interpolation processing by using the pixel outputs obtained through the culled read from the image sensor 103 is illustrated in clear correspondence to the left-side diagram and the central diagram.

A ⅓ culled read is executed at the image sensor 103 in the live view mode in the embodiment. In other words, the pixels in the third, sixth, ninth and twelfth rows are culled (i.e., are not read out) as indicated in FIG. 4 (see the right-side diagram and the central diagram). It is to be noted that whenever a culled read is executed at the image sensor 103, read control is executed to ensure that the signals from the AF pixel rows (e.g., the eighth row) are always read out (i.e., so as to ensure that the pixels in the AF pixel rows are not culled).

The pixel outputs obtained through the culled read from the image sensor 103 are taken into the control device 104. The abridged interpolation processing unit 1041 executes pixel combine processing so as to combine the pixel outputs originating from a pair of same-color pixel rows located close to each other. Namely, the pixel combine processing is executed so as to combine the pixel outputs from G-B pixel rows (e.g., from the second and fourth rows) and also combine the pixel outputs from R-G pixel rows (e.g., from the fifth and seventh rows), in the central diagram in FIG. 4. The tenth row, which is a G-B pixel row would be paired up with the eighth pixel row in the pixel combine processing. However, the eighth row is an AF pixel row and thus, the outputs from the AF pixel row (eighth row) are not used in the pixel combine processing (see the dashed-line arrow between the central diagram and the right-side diagram). Accordingly, a same-color row (the fourth G-B pixel row) near the AF pixel row is designated as a pixel row 4b to be used in the interpolation processing in place of the eighth AF pixel row.

In other words, the pixel outputs (the outputs pertaining to the image data corresponding to the AF pixels) from a combined pixel row 4a, which would otherwise indicate the results obtained by “combining the pixel outputs from the eighth and tenth rows”, are instead obtained through interpolation executed by using the pixel outputs (4b) from the fourth row near the AF pixel row (eighth row): In more specific terms, the interpolation processing is executed as expressed in (1) and (2) below. Interpolation operation executed to determine the output corresponding to each G-component pixel in the combined pixel row 4a:

pixel row 4a(Gn)={G(fourth row)×a}+{G(tenth row)×b} (1)

Interpolation operation executed to determine the output corresponding to each B-component pixel in the combined pixel row 4a:

pixel row 4a(Bn)={B(fourth row)×a}+{B(tenth row)×b} (2)

It is to be noted that 4a(Gn) represents the output from each G-component pixel (Gn) in the combined pixel row 4a, that G(fourth row) represents the output from each G-component pixel in the fourth row, that G(tenth row) represents the output from each G-component pixel in the tenth row, that 4a(Bn) represents the output from each B-component pixel (Bn) in the combined pixel row 4a, that B(fourth row) represents the output from each B-component pixel in the fourth row, and that B(tenth row) represents the output from each B-component pixel in the tenth row. a and b each represent a variable weighting coefficient that determines a pixel combination ratio (a coefficient that can be adjusted in correspondence to the specific pixel row used in the operation). The coefficient b achieves a weighting resolution far greater than that of the coefficient a. In addition, the coefficients a and b take on values determined in correspondence to the distances from the interpolation target row 4a to the nearby pixels (the individual pixels in the fourth and tenth pixel rows) used in the pixel combine processing.

The variable weighting coefficient b assures a weighting resolution far greater than that of the coefficient a, since the position (the gravitational center position) of the combined pixel row 4a is closer to the position of the tenth row than to the position of the fourth row, of the two rows paired up for the pixel combine processing and the accuracy of the pixel combine processing can be improved by ensuring that finer weighting resolution can be set for the closer row.

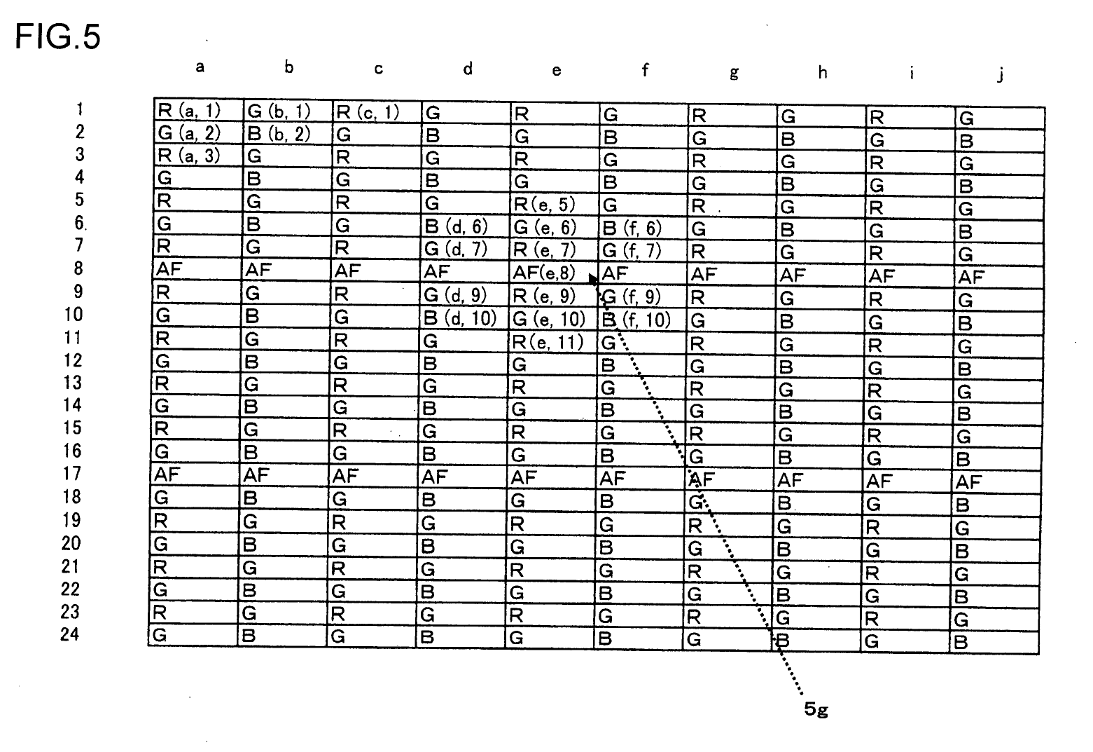

As described above, the abridged interpolation processing unit 1041 executes interpolation processing so as to generate pixel outputs for the combined pixel row 4a as expressed in (1) and (2) above, i.e., by using the pixel outputs from the same-color regular pixel row 4b (a regular pixel row 4b made up with same-color pixels) assuming the position closest to the AF pixel row, instead of the outputs from the AF pixel row itself. Next, the operation executed in the still shooting mode in step S111 is described in further detail in reference to FIG. 5. FIG. 5 shows part (including an AF pixel 5g and regular pixels surrounding the AF pixel 5g) of the image sensor 103, having been described in reference to FIG. 2, with complementary reference numerals added thereto. An all-pixel read is executed at the image sensor 103 in the still shooting mode in the embodiment. Namely, signals are output from all the pixels in FIG. 4.

The pixel outputs obtained from the image sensor 103 through the all-pixel read are taken into the memory (SDRAM) 1042 of the control device 104. Then, the still image interpolation processing unit 1043 generates image signals corresponding to the positions taken up by the individual AF pixels through interpolation executed by using the outputs from nearby regular pixels and the outputs from the AF pixels themselves. Since the specific operation method adopted in the interpolation processing is disclosed in Japanese Laid Open Patent Publication No. 2009-303194, the concept of the arithmetic operation method is briefly described at this time. When generating through interpolation an image signal corresponding to the AF pixel 5g (taking up a column e and row 8 position) among the AF pixels in FIG. 5, for instance, the image signal to be generated through the interpolation in correspondence to the AF pixel 5g needs to be a G-component image signal since the AF pixel 5g occupies a position at which a G-component filter would be disposed in the RGB Bayer array.

Accordingly, at each of regular pixels corresponding to the various color components (R, G, B) present around the AF pixel 5g, data corresponding to the missing color components are calculated through interpolation executed based upon the data provided at the surrounding regular pixels so as to estimate the level of the white-color light component in the particular regular pixel. For instance, the pixel value representing the white-color light component at the G pixel occupying a column e and row 6 position may be estimated through an arithmetic operation whereby an R-component value is determined through interpolation executed based upon the R-component data provided from the nearby R pixels (the nearby R pixels occupying a column e and row 5 position and a column e and row 7 position and a B-component value is determined through interpolation executed based upon the B-component data provided from the nearby B pixels (the nearby B pixels occupying a column d and row 6 position and a column f and row 6 position).

Next, based upon the estimated pixel values for the white-color light component, each having been estimated in correspondence to one of the surrounding pixels and the output value indicated at the AF pixel 5g (the output value at the AF pixel 5g indicates the white-color light component level itself), the distribution of the white-color light component pixel values in the surrounding pixel area containing the AF pixel 5g is obtained. In other words, the variance among the pixel outputs obtained by substituting white-color light component values for all the output values in the surrounding pixel area is ascertained. This distribution (variance) information is used as an index for determining an optimal gain to be actually added or subtracted at the AF pixel position when generating through interpolation a G-component output at the position occupied by the AF pixel 5g.

Then, based upon the white-color light component pixel value distribution information (variance information) and the distribution of the output values at G-component pixels (G (column e and row 6), G (column d and row 7), G (column f and row 7), G (column d and row 9), G (column f and row 9) and G (column e and row 10)) surrounding the AF pixel 5g, a G-component pixel value is determined in correspondence to the position occupied by the AF pixel 5g.

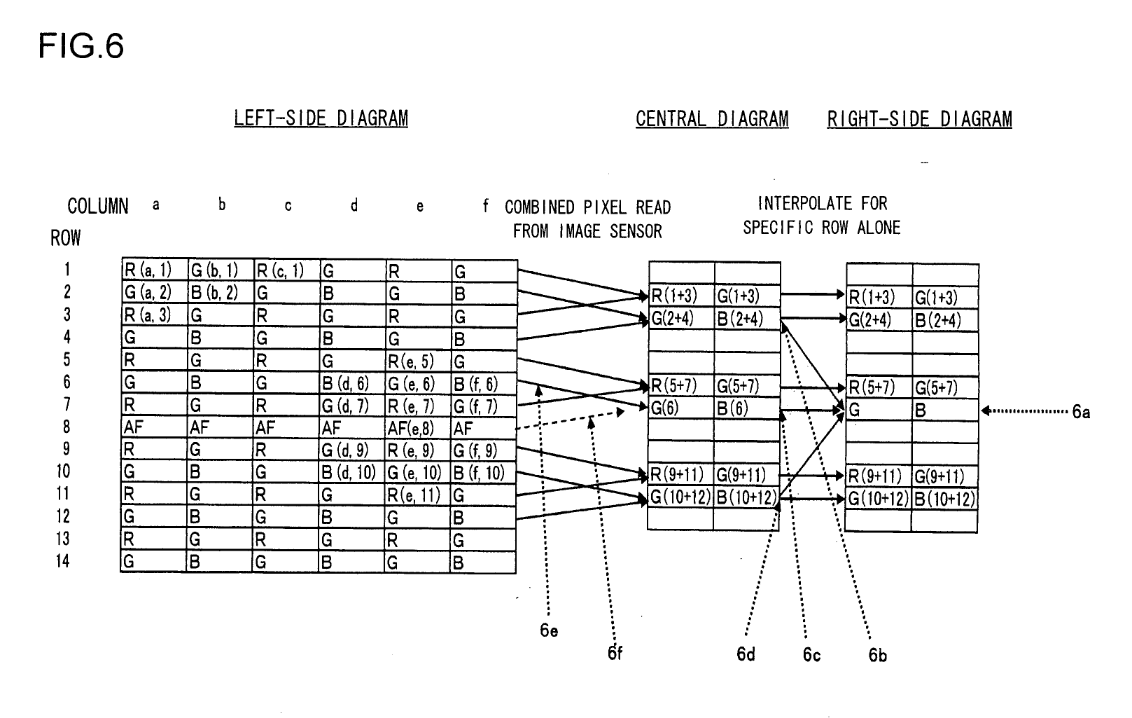

Next, the operation executed in step S117 in the video shooting mode while the contrast AF method is selected as the AF method is described in detail in reference to FIG. 6. In the left-side diagram in FIG. 6, part of the image sensor 103 having been described in reference to FIG. 2, is shown (part of the image sensor over a range from the first through fourteenth rows). In the central diagram in FIG. 6, signals read out from the image sensor 103 through a combined pixel read are shown in clear correspondence to the left-side diagram. In the right-side diagram in FIG. 6, the interpolation method adopted in the abridged interpolation processing unit 1041 of the control device 104 when executing interpolation processing by using pixel outputs obtained through the combined pixel read from the image sensor 103 is illustrated in clear correspondence to the left-side diagram and the central diagram.

In the embodiment, a combined two-pixel read is executed at the image sensor 103 in the contrast AF video shooting mode. This combined two-pixel read is executed by combining pixels in same-color pixel rows (by combining pixels in the odd-numbered R-G pixel rows and combining pixels in the even-numbered G-B pixel rows in the embodiment), as indicated in FIG. 6 (see the right-side diagram and the central diagram). However, the combined pixel read is not executed for the pixel outputs from the AF pixels in each AF pixel row (see the AF pixel row output indicated by the dotted line 6f in FIG. 6) and the pixel outputs from the pixels in the regular pixel row that would be paired up with the AF pixel row (see the regular pixel row output indicated by the solid line 6e in FIG. 6), but instead the outputs from either the AF pixel row or the regular pixel row are read out. When the focus detection is executed through the contrast detection method, the outputs from the regular pixel row, instead of the AF pixel row are read out, as indicated in FIG. 6, which shows the outputs corresponding to the solid line 6e is read out without reading out the outputs corresponding to the dotted line 6f.

The pixel outputs having been read out through the combined pixel read from the image sensor 103 are taken into the control device 104. The abridged interpolation processing unit 1041 then executes interpolation processing for the regular pixel row output (the pixel outputs from the single regular pixel row, i.e., the sixth row) that has been read out by itself without being paired up with another pixel row output. In other words, the pixel outputs for a combined pixel row 6a (the outputs pertaining to image data corresponding to the AF pixels), which would otherwise result from a combined pixel read of the sixth and eighth rows, are generated through interpolation executed by using the outputs from same-color combined pixel rows 6b and 6d near the combined pixel row 6a and the output from a pixel row 6c having been read out through a direct read instead of the combined pixel read. More specifically, the interpolation is executed as expressed in (3) and (4) below.

Interpolation operation executed to determine the output corresponding to each G-component pixel in the combined pixel row 6a:

pixel row 6a(Gn)={G(6b)×c}+{G(6c)×d}+{G(6d)×e} (3)

Interpolation operation executed to determine the output corresponding to each B-component pixel in the combined pixel row 6a:

pixel row 6a(Bn)={B(6b)×c}+{B(6c)×d}+{B(6d)×e} (4)

It is to be noted that 6a (Gn) represents the output of each G-component pixel (Gn) in the combined pixel row 6a, that G(6b) represents the output of each G-component pixel among the combined pixel outputs resulting from the combined pixel read of the second and fourth rows, that G(6c) represents the output of each G-component pixel in the single sixth row and that G(6d) represents the output of each G-component pixel among the combined pixel outputs resulting from the combined pixel read of the tenth and twelfth rows. 6a (Bn) represents the output of each B-component pixel (Bn) in the combined pixel row 6a, B(6b) represents the output of each B-component pixel among the combined pixel outputs resulting from the combined pixel read of the second and fourth rows, B(6c) represents the output of each B-component pixel in the single sixth row and B(6d) represents the output of each B-component pixel among the combined pixel outputs resulting from the combined pixel read of the tenth and twelfth rows. The symbols c through e each represent a variable weighting coefficient that determines a pixel combination ratio (a coefficient that can be adjusted) in correspondence to the specific pixel row used in the operation). The coefficient d achieves a weighting resolution far greater than those of the coefficients c and e. In addition, the coefficients c through e take on values determined in correspondence to the distances from the interpolation target row 6a to the nearby pixels (the individual pixels in the combined pixel rows 6b and 6d and the pixel row 6c) used in the pixel combine processing. The weighting resolution of the variable weighting coefficient d is set far greater than those of the variable weighting coefficients c and e for a reason similar to that having been described in reference to the weighting coefficients a and b.

As described above, the abridged interpolation processing unit 1041 executes interpolation processing so as to generate pixel outputs for the combined pixel row 6a as expressed in (3) and (4) above, i.e., by using the outputs from the regular pixel row 6c having been read out instead of the AF pixel row output (the regular pixel row output that has been read out by itself instead of paired up with another pixel row for the combined pixel read) and the outputs from the same-color combined pixel rows 6b and 6d present around (above and below) the regular pixel row 6c.

Next, the operation executed in step S119 in the phase difference AF video shooting mode by using the outputs from the AF pixels 2a at the image sensor 103 is described in detail in reference to FIG. 7. In the left-side diagram in FIG. 7, part of the image sensor 103 having been described in reference to FIG. 2 is shown (part of the image sensor over a range from the first through fourteenth rows). In the central diagram in FIG. 7, signals read out from the image sensor 103 through a combined pixel read are shown in clear correspondence to the left-side diagram. In the right-side diagram in FIG. 7, the interpolation method adopted in the abridged interpolation processing unit 1041 of the control device 104 when executing interpolation processing by using pixel outputs obtained through the combined pixel read from the image sensor 103 is illustrated in clear correspondence to the left-side diagram and the central diagram.

In the embodiment, a combined two-pixel read is executed at the image sensor 103 in the phase difference AF video shooting mode. This combined two-pixel read is executed by combining pixels in same-color pixel rows (by combining pixels in the odd-numbered R-G pixel rows and combining pixels in the even-numbered G-B pixel rows in the embodiment), as indicated in FIG. 7 (see the right-side diagram and the central diagram). However, as has been explained, the combined pixel read is not executed for each AF pixel row and the regular pixel row that would be paired up with the AF pixel row, but instead the AF pixel row output alone is read out when the phase difference AF method is selected as the focus detection method, as indicated in FIG. 7, which shows that the AF pixel row output indicated by the solid line 7d is read out by itself without reading out the regular pixel row output indicated by the dotted line 7e.

The pixel outputs having been read out through the combined pixel read from the image sensor 103 are taken into the control device 104. The abridged interpolation processing unit 1041 then executes interpolation processing for the AF row output (the pixel outputs from the eighth row alone) that has not been paired up with another pixel row output for the combined pixel read. In other words, the pixel outputs for a combined pixel row 7a (the outputs pertaining to image data corresponding to the AF pixels), which would otherwise result from a combined pixel read of the sixth and eighth rows, are generated through interpolation executed by using the outputs from same-color combined pixel rows 7b and 7c near the combined pixel row 7a. More specifically, the interpolation is executed as expressed in (5) and (6) below.

Interpolation operation executed to determine the output corresponding to each G-component pixel in the combined pixel row 7a:

pixel row 7a(Gn)={G(7b)×f}+{G(7c)×g} (5)

Interpolation operation executed to determine the output corresponding to each B-component pixel in the combined pixel row 7a:

pixel row 7a(Bn)={B(7b)×f}+{B(7c)×g} (6)

It is to be noted that 7a (Gn) represents the output of each G-component pixel (Gn) in the combined pixel row 7a, that G(7b) represents the output of each G-component pixel among the combined pixel outputs resulting from the combined pixel read of the second and fourth rows and that G(7c) represents the output of each G-component pixel among the combined pixel outputs resulting from the combined pixel read of the tenth and twelfth rows. 7a (Bn) represents the output of each B-component pixel (Bn) in the combined pixel row 7a, B(7b) represents the output of each B-component pixel among the combined pixel outputs resulting from the combined pixel read of the second and fourth rows and B(7c) represents the output of each B-component pixel among the combined pixel outputs resulting from the combined pixel read of the tenth and twelfth rows. f and g each represent a variable weighting coefficient that determines a pixel combination ratio (a coefficient that can be adjusted in correspondence to the specific pixel row used in the operation). The values representing the weighting resolutions of the coefficients f and g are equal to each other. In addition, the weighting coefficients f and g take values equal to each other. It is to be noted that the coefficients f and g take values determined in correspondence to the distances from the interpolation target row 7a to the nearby pixels (the individual pixels in the combined pixel rows 7b and 7c). Equal values are assumed for the weighting resolutions of the variable weighting coefficients f and g since the interpolation operation is executed by using the outputs from nearby pixels, which are set apart from the interpolation target row 7a by significant distances.

As described above, the abridged interpolation processing unit 1041 executes interpolation processing so as to generate pixel outputs for the combined pixel row 7a as expressed in (5) and (6) above, i.e., by using the outputs from the same-color combined pixel rows 7b and 7c assuming the positions around (above and below) the interpolation target AF pixel row 7a.

It is to be noted that a pixel value for the interpolation target pixel is generated by using the pixel values indicated at two same-color pixels, one located above and the other located below the interpolation target pixel, through the interpolation processing executed as expressed in (1) through (6). While better interpolation accuracy is assured by executing the interpolation by using a greater number of nearby pixel values, such interpolation processing is bound to be more time-consuming. Accordingly, the control device 104 may adjust the number of nearby pixels to be used for the interpolation processing in correspondence to the frame rate. Namely, the interpolation processing may be executed by using a smaller number of nearby pixels at a higher frame rate, whereas the interpolation processing may be executed by using a greater number of nearby pixels at a lower frame rate.

An optimal value at which the interpolation processing can be completed within the frame rate interval should be selected in correspondence to the frame rate and be set as the number of nearby pixels to be used in the interpolation processing. For instance, the interpolation processing may be executed by using the pixel values at pixels in two upper same-color rows and two lower same-color rows when the frame rate is 30 FPS, whereas the interpolation processing may be executed by using the pixel values in one upper same-color row and one lower same-color row when the frame rate is at 60 FPS. Through these measures, it is ensured that the interpolation processing will be completed within the frame rate interval regardless of the frame rate setting, and furthermore, whenever the frame rate is low and thus there is more processing time, the interpolation processing accuracy can be improved by using a greater number of pixel values at nearby pixels in the interpolation processing.

The following advantages are achieved through the embodiment described above.

(1) While shooting a video image in the contrast AF video shooting mode, regular pixel signals (image signals/color information) read out by themselves from the image sensor without being paired up with other pixel signals for the combined pixel read, too, are used in the interpolation processing. As a result, a higher-definition interpolated image is generated, and since the length of time required for the interpolation operation itself is not different from the length of time required for the interpolation operation executed in the phase difference AF operation mode, the photographic frame rate does not need to be lowered.

(2) The interpolation processing is executed in the video shooting mode by switching to the optimal interpolation processing method in correspondence to the focus detection method. As a result, interpolation for the interpolation target pixel can be executed through the optimal method, best suited for the focus adjustment method. More specifically, in the phase difference AF video shooting mode, the interpolation processing is executed without using the signals from AF pixel rows that are read out by themselves from the image sensor without being paired up with signals from other pixel rows for the combined pixel read, so as to enable high-speed interpolation processing and sustain a higher photographic frame rate. In the contrast AF video shooting mode, on the other hand, the interpolation processing is executed by using signals (image signals/color information) read out by themselves from the image sensor without being paired up with signals from other pixel rows for the combined pixel read, as well. As a result, a higher definition interpolated image is generated, and since the length of time required for the interpolation operation itself is not different from the length of time required for the interpolation operation executed in the phase difference AF operation mode, the photographic frame rate does not need to be lowered.

(3) The number of nearby pixels used in the interpolation processing is adjusted in correspondence to the photographic frame rate. The length of time required for the interpolation processing can thus be adjusted in correspondence to the photographic frame rate and the interpolation processing executed for each interpolation target pixel can be completed within the photographic frame rate interval.

(4) The interpolation processing is executed by using a smaller number of nearby pixels at a higher photographic frame rate, whereas the interpolation processing is executed by using a greater number of nearby pixels at a lower photographic frame rate.

Through these measures, it is ensured that the interpolation processing will be completed within the frame rate interval regardless of the frame rate setting, and furthermore, whenever the frame rate is low and thus there is more processing time, the interpolation processing accuracy can be improved by using a greater number of nearby pixels in the interpolation processing.

(5) A pixel value for the interpolation target pixel is generated through interpolation executed by using the pixel values indicated at a plurality of nearby pixels present around the interpolation target pixel. As a result, the pixel value corresponding to the interpolation target pixel can be generated through interpolation quickly and with a high level of accuracy.

(6) The combination ratios at which the pixel values are combined in the interpolation processing are determined in correspondence to the distances between the interpolation target pixel and the nearby pixels used for purposes of the interpolation processing. Thus, since the combination ratio of a nearby pixel closer to the interpolation target pixel is raised, better interpolation accuracy is assured.

—Variations—

It is to be noted that the camera achieved in the embodiment as described above allows for the following variations.

(1) When shooting a still image, the control device 104 in the embodiment described above generates through interpolation a pixel value for the interpolation target AF pixel by using the pixel values indicated at same-color nearby pixels as well as the pixel value indicated at the interpolation target AF pixel. As an alternative, when shooting still image, the control device 104 may generate a pixel value for the interpolation target AF pixel by using a brightness signal included in the focus detection signal output from the AF pixel and the pixel values indicated at same-color nearby pixels present around the interpolation target AF pixel. The interpolation processing executed by using the brightness signal output from the interpolation target AF pixel as well as the pixel values indicated at the nearby pixels as described above will assure better interpolation accuracy than the interpolation accuracy achieved by using the nearby pixel values alone.

(2) The description has been given in reference to the embodiment on an example in which a pixel value corresponding to an AF pixel is generated through interpolation in conjunction with a culled pixel read, as indicated in FIG. 4. However, the present invention is not limited to this example and it may also be adopted when generating image data by reading out pixel values from all the pixels at the image sensor 103.

Through the embodiment described above, image signals can be generated through an optimal interpolation method during a video shooting operation.

It is to be noted that as long as the functions characterizing the present invention are not compromised, the present invention is not limited to any of the structural details described in reference to the embodiment. In addition, the embodiment may be adopted in combination with a plurality of variations.

The above described embodiment is an example, and various modifications can be made without departing from the scope of the invention.

1. A camera comprising:
an image sensor that includes a first pixel row at which a plurality of first pixels that output focus adjustment signals are disposed, and second pixel rows each made up exclusively with a plurality of second pixels that output image data generation signals; and
an interpolation processing device that executes, when outputs from a plurality of pixel rows are provided as a combined output according to a predetermined combination rule, interpolation processing for an output from a specific second pixel row which would be combined with an output from the first pixel row according to the predetermined combination rule, by using the output of the specific second pixel row and a combined output of second pixel rows present around the specific second pixel row.

2. A camera according to claim 1, wherein:
the interpolation processing device executes the interpolation processing in a second video shooting state, in which a video image is shot by adopting a second focus adjustment method whereby focus adjustment is executed based upon outputs of the second pixels.

3. A camera according to claim 2, further comprising:
a switching device capable of switching to one of the second video shooting state and a first video shooting state in which a video image is shot by adopting a first focus adjustment method whereby focus adjustment is executed based upon outputs of the first pixels, wherein:
the interpolation processing device selects an interpolation processing method in correspondence to a shooting state selected via the switching device.

4. A camera according to claim 3, wherein:
the interpolation processing device executes the interpolation processing by altering a volume of information used in the interpolation processing in correspondence to the shooting state.

5. A camera according to claim 3, wherein:
the interpolation processing device uses a greater volume of information in the interpolation processing in the second video shooting state than in the first video shooting state.

6. A camera according to claim 2, wherein:
the first video shooting state includes at least one of a video shooting state in which a video image is shot and is recorded into a recording medium and a live view image shooting state in which a video image is shot and displayed at a display device without recording the video image into the recording medium.

7. A camera according to claim 3, further comprising:
a third shooting state in which a still image is shot, wherein:
the switching device is capable of switching to the first video shooting state, the second video shooting state or the third shooting state; and
once the switching device switches to the third shooting state, the interpolation processing device executes interpolation processing to generate image data generation information corresponding to the first pixels through an interpolation processing method different from the interpolation processing method adopted in the first video shooting state or the second video shooting state.

8. A camera according to claim 7, wherein:
in the third shooting state, the interpolation processing device executes interpolation processing to generate the image data generation information corresponding to each of the first pixels by using an output of the first pixel and outputs of the second pixels present around the first pixel.

9. A camera according to claim 1, wherein:
the interpolation processing device adjusts a number of second pixels used in the interpolation processing in correspondence to a frame rate at which the video image is shot.

10. A camera according to claim 9, wherein:
the interpolation processing device executes the interpolation processing by using a smaller number of second pixels at a higher frame rate.

11. A camera according to claim 1, wherein:
the interpolation processing device determines combination ratios for outputs of the second pixels used in the interpolation processing in correspondence to distances between each first pixel and the second pixels used in the interpolation processing.
